(19) United States
(12) Patent Application Publication
(10) Pub. No.: US 2019/0178517 A1
(43) Pub. Date: Jun. 13, 2019

(54) Apparatus and Method for Operating an Intelligent Air Conditioning and Heating System

(71) Applicant: Coil Winding Specialist, Inc, Orange, CA (US)

(72) Inventor: James L Lau, Tustin, CA (US)

(21) Appl. No.: 15/837,487

(22) Filed: Dec. 11, 2017

(51) Int. Cl. F24F 11/46; F24F 11/65; F24F 11/86; F24F 11/49; G05B 19/042

(52) U.S. Cl. CPC F24F 11/46; F24F 11/65; F24F 2110/10; F24F 11/49; G05B 19/0426; F24F 11/86

(57) ABSTRACT

An intelligent air conditioning and heating apparatus and method of operation conserves energy and life span of an air conditioning and heating unit. The apparatus provides an air conditioning and heating unit having a cooling compressor or heat exchanger, respectively, that power off when a predetermined temperature or an operational duration, such as 15 minutes, has been reached. While the cooling compressor and heat exchanger are non-operational, a fan continues blowing for a predetermined non-operational duration, about 3 minutes, directly on the cooling compressor or heat exchanger to carry the cool or hot air, maintaining the predetermined temperature. The apparatus and method also enable manual or automated bypassing of the powering off function. A bypass switch overrides powering off the cooling compressor or heat exchanger to maintain operation of the air conditioning and heating unit when the predetermined temperature is not achievable due to extreme temperature or humidity conditions.

### FIELD OF THE INVENTION

The present invention relates generally to an apparatus and method for operating an intelligent air conditioning and heating system. More so, the present invention relates to an apparatus and a method for energy savings during the operation of an air conditioning and heating unit by selectively and temporarily powering off a cooling compressor or heat exchanger, and powering on a fan to blow on the cooling compressor or heat exchanger when a predetermined temperature or an operational duration has been reached, and further providing a bypass switch that overrides the function of powering off the cooling compressor or heat exchanger, so as to maintain operation of the air conditioning and heating unit in normal operation when the user set temperature is not achievable due to extreme temperature conditions; and whereby the bypass switch is actuated manually, or automatically actuated by detecting at least one intelligently sensed event, such as detecting the presence of occupants in a room, the time of day, noise, body heat, and the like.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, heating, ventilation, and air conditioning (HVAC) is the technology of indoor environmental comfort. HVAC provides thermal comfort and acceptable indoor air quality. Often, air conditioning and refrigeration are provided through the removal of heat. The heat can be removed through radiation, convection, or conduction. Refrigeration conduction media such as water, air, ice, and chemicals are referred to as refrigerants. The heaters are appliances whose purpose is to generate heat for the building. This can be done via central heating. Heaters may include electric, boiler, furnace, or heat pump to heat water, steam, or air in a central location such as an air handler unit in a home, or a mechanical furnace room in a large building.

There are several types or categories of HVAC systems. The 2 most common categories are centralized HVAC and decentralized HVAC. Each category has its own advantages and disadvantages and are used in different environments. For centralized HVAC, there are 2 main types as well. The first type is using chilled water as cooling medium and large boilers as heating medium, and is mainly used for large industrial or commercial facilities. The second type is using refrigerant in the compressors as cooling medium and heat pump or gas furnace or electrical heat strips as heating medium, and is mainly used in smaller commercial buildings and residential homes. For residential homes, these types of HVAC are also call split system where the air conditioning compressor unit is split away from the air handler unit where the heat exchangers and blower fan are located. For centralized HVAC, the air handler unit distributes the conditioned air throughout the multiple rooms or spaces using a network of duck works.

The decentralized HVAC serves a single room or a small conditioned space. It has no duct work. It is also called the ductless system or mini-split. The decentralized HVAC unit is typically located in the room itself or adjacent to the room. These HVAC are usually a direct expansion types. Examples of these decentralized HVAC are packaged through the wall of the room, window mounted, room mounted with compressor outside the room (mini split), etc. The packaged through the wall type is also called the Package Terminal Air Conditioning (PTAC) and Packaged Terminal Heat Pumps (PTHP).

In these direct expansion types of HVAC, the air is cooled directly through the heat exchanger of the refrigerants. The principal advantages of these HVAC systems are lower initial cost, simplified installation, no duck works and pipes, independent zone controls, and can be individually metered. The major disadvantages as compared to centralized HVAC system are shorter equipment life, higher audible noise, and much higher energy consumption in kW per ton basis.

PTAC and PTHP are commonly found in hotels, motels, apartments, condos, schools, medical facilities and offices nationwide. In fact, there are more PTACs and PTHPs installed in the United States than all the centralized HVAC systems combined.

Many PTACs and PTHPs has a 24Vac thermostat interface so that a thermostat can be used to set the desired room temperature. Due to the much energy consumption of the PTAC and PTHP, there is a need for an energy saving apparatus that can be installed in the PTAC/PTHP that can save energy.

The present invention called PTX as described herein is an apparatus that will provide energy savings to a PTAC and PTHP and represents a cost-effective measure to reduce energy consumption to these HVAC industry workhorses.

The PTAC/PTHP typically operates the ventilation fan for 0 second to 30 seconds after the heater or air conditioner has power down after the room set temperature has been reached. However, after the 30 seconds duration, the heater surface or the air conditioner cooling coil still have residual energy left. This wasted energy is not delivered to the conditioned space when the blower fan stops blowing. The PTX apparatus works by extending the blower fan to run a few additional minutes while powering off the compressor or heater after continuous runs for a few minutes, and which both the fan extension and the powering off can be bypassed if the conditions are not suitable to ensure that the occupant remains comfortable.

Other proposals have involved energy saving methods for HVAC systems. The problem with these devices and energy saving methods are that they do not regulate the powering on and off of the cooling compressor and heat exchanger and a means of bypassing them when conditions are not suitable. Also, there is no triggering event that bypasses the powering off of the air conditioning and heating units. Even though the above cited energy saving methods for HVAC systems meets some of the needs of the market, they are not an intelligent controls or air conditioning and heating system and method of operation. More so, the present invention relates to an apparatus and a method for energy savings during the operation of an air conditioning and heating unit by selectively and temporarily powering off a cooling compressor or heat exchanger while powering on the blower fan to blow on the cooling compressor or heat exchanger when a predetermined temperature or an operational duration has been reached, and further providing a bypass switch that overrides the function of powering off the cooling compressor or heat exchanger.

### SUMMARY

Illustrative embodiments of the disclosure are generally directed to an apparatus and method for operating an intelligent air conditioning and heating system. The apparatus and method help to conserve energy and the life span of an air conditioning and heating unit by selectively and temporarily powering off or pausing a cooling compressor or heat exchanger, while powering on the blower fan to blow on the cooling compressor or heat exchanger when a predetermined temperature or an operational duration has been reached. The system and method also enable manual or automated bypassing of this powering off function.

In one embodiment, the apparatus and method teach an air conditioning and heating unit having a cooling compressor or heat exchanger, respectively, that powers off when a predetermined operational duration, such as 15 minutes, has been reached. However, while the cooling compressor and heat exchanger are forced to become non-operational, the blower fan continues blowing for a predetermined non-operational duration, such as about 3 minutes, directly on the cooling compressor or heat exchanger to carry the cool or hot air, and thereby maintain the conditioned air into the conditioned space.

In another embodiment, the apparatus is integrated into a thermostat making the thermostat the energy conservation unit.

Thus, the fan blows air across the condensation from the cooling compressor coils or the dissipating heat from the heat exchanger to blow cooled air by evaporative effects or heated air from the heater residual energy, to save energy even though the conditioned room user set temperature may not be maintained. By temporarily powering off the cooling compressor or heat exchanger, energy is saved. After 3 minutes, the cooling compressor or heat exchanger power back on, with the blower fan continues blowing. Furthermore, a bypass switch overrides the function of powering off the cooling compressor or heat exchanger, to maintain normal operation of the air conditioning and heating unit when the predetermined temperature is not achievable due to extreme temperature or humidity conditions.

In one embodiment, the method of operating an intelligent air conditioning and heating system, comprises:
installing an energy conservation module (PTX) between a wired or a wireless thermostat base module in the conditioned room and the thermostat interface of the air conditioning unit and a heater unit (PTAC/PTHP) and configuring the energy saving unit (PTX) to perform a set of functions comprising:
forcing the blower fan of the air conditioning unit and heater unit to blow air against the cooling compressor or the heat exchanger for a variable period, after powering off the heater or compressor due to conditioned room has met the thermostat's set temperature;
forcing the powering off the cooling compressor or the heat exchanger for a predetermined non-operational duration when an operational duration is reached, even though the conditioned room has not met the thermostat's set temperature and the thermostat is still calling for powering on of the cooling compressor or the heat exchanger;
forcing the blower fan of the air conditioning unit and heater unit to blow air against the cooling compressor or the heat exchanger after forcing the powering off the heater or compressor that are not due to actions of the thermostat;
powering on the cooling compressor or the heat exchanger after the predetermined non-operational duration has lapsed;
manually bypassing, with at least one bypass switch, the step of forced powering off the cooling compressor or the heat exchanger and the steps of forcing the blower fan of the air conditioning unit and heater unit to blow air against the cooling compressor or the heat exchanger for a variable period, after powering off the heater or compressor due to conditioned room has met the thermostat's set temperature

In another embodiment, the method of operating an intelligent air conditioning and heating system, comprises:
installing an energy conservation module (PTX) between a wired or a wireless thermostat base module in the conditioned room and the thermostat interface of the air conditioning unit and a heater unit and configuring the energy saving unit (PTX) to receive ambient temperature data wirelessly or through cable and to communicate with air conditioning unit and a heater unit.
configuring the energy saving unit (PTX) to perform a set of functions comprising: setting a predetermined temperature for the conditional room ambient air;
sensing the temperature of the ambient air that is being heated or cooled;
powering off the cooling compressor or the heat exchanger for a predetermined non-operational duration when the predetermined ambient temperature or an operational duration is reached;
forcing the blower fan of the air conditioning unit and heater unit to blow air against the cooling compressor or the heat exchanger after powering off the heater or compressor;
powering on the cooling compressor or the heat exchanger after the predetermined non-operational duration has lapsed;
manually bypassing, with at least one bypass switch, the step of powering off the cooling compressor or the heat exchanger; and
automatically bypassing, with the at least one bypass switch, the step of powering off the cooling compressor or the heat exchanger when detecting at least one intelligently sensed event.

In another aspect, the air conditioning and heating unit comprises a packaged terminal air conditioner and a packaged terminal heat pump.

In another aspect, the air conditioning and heating unit is operational with low voltage terminals that remotely connect to the thermostat through Bluetooth.

In another aspect, the intelligent air conditioning and heating system is in communication with the fan, the cooling compressor, and the heat exchanger.

In another aspect, the energy conservation module comprises a thermostat terminal and a microprocessor for communicating temperature.

In another aspect, the step of manually shutting off the cooling compressor or the heat exchanger is actuated remotely through Bluetooth technology, radio frequency signals, Wi-Fi controls, or ZigBee.

In another aspect, the operational duration is about fifteen minutes.

In another aspect, the predetermined non-operational duration is about three minutes.

In another aspect, the intelligent air conditioning and heating system comprises a humidity sensor working in conjunction with the thermostat.

In another aspect, the at least one intelligently sensed event detecting an ambient temperature, an ambient humidity, or both.

In another aspect, the at least one intelligently sensed event includes at least one of the following: detecting the presence of a person in a room, detecting the presence of mobile phone signals in the room indicating occupant in the room, detecting body heat, detecting motion, detecting door lock positions of on or off, detecting television sounds, detecting the time of day, detecting television remote signals being used over a period, detecting noise from a door closing and opening.

In another aspect, the blower fan comprises a low-speed fan and a high-speed fan.

In another aspect, the method comprises a step of operating the blower fan for a variable period if the cooling compressor or the heat exchanger power off before the operational duration is complete.

One objective of the present invention is to conserve energy and life span of the air conditioning and heating unit.

Another objective is to automate the powering off of the cooling compressor and heat exchanger for a predetermined non-operational duration of about three minutes, to conserve energy.

Yet another objective is to allow the fan to blow cool air and heat for three minutes while the cooling compressor and heat exchanger are powered off.

Yet another objective is to enable the powering off of the cooling compressor and heat exchanger to be bypassed with a bypass switch.

Yet another objective is to enable both manual and automated bypassing.

Yet another objective is to provide sensors that dictate whether to actuate the bypass switch.

Yet another objective is to provide an inexpensive way to manufacture intelligent air conditioning and heating system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary intelligent air conditioning and heating apparatus, in accordance with an embodiment of the present invention;

FIG. 2 illustrates a block diagram of an exemplary energy conservation module (PTX) in communication with the thermostat interface of cooling and heating unit (PTAC/PTHP) in accordance with an embodiment of the present invention; and

FIG. 3 illustrates a flowchart of an exemplary method for operating an intelligent air conditioning and heating apparatus, in accordance with an embodiment of the present invention.

Like reference numerals refer to like parts throughout the various views of the drawings.

### DETAILED DESCRIPTION OF THE INVENTION

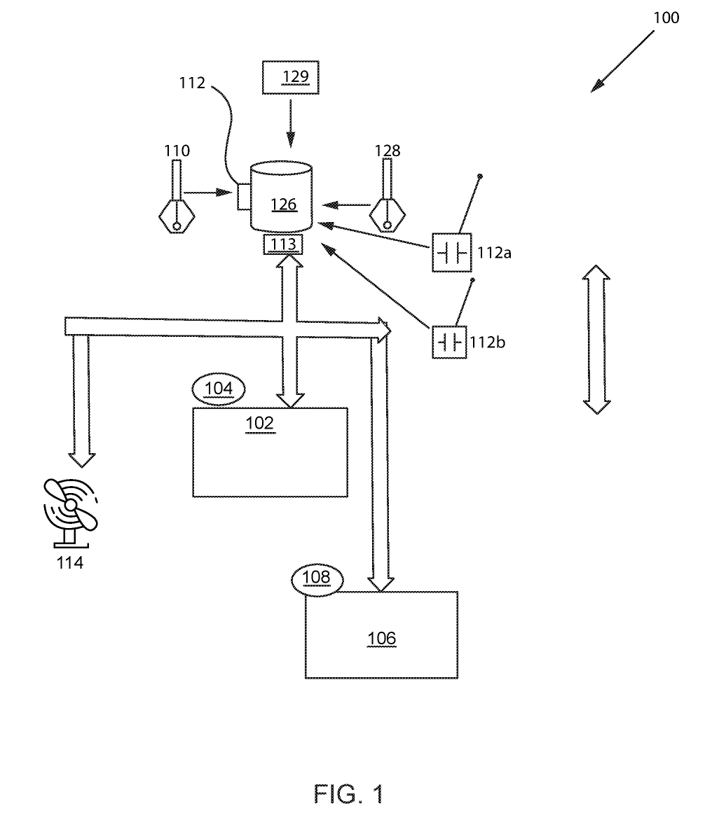

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

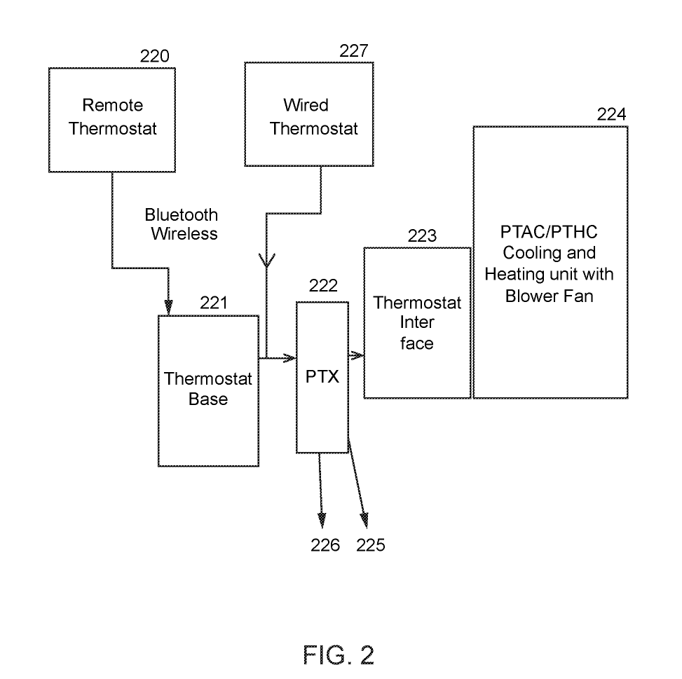

An apparatus 100 and method 200 for operating an intelligent air conditioning and heating system is referenced in FIGS. 1-3. The apparatus 100 and method 200 helps to conserve energy and the life span of an air conditioning unit 102 and heating unit 106 by selectively and temporarily powering off a cooling compressor 104 or heat exchanger 108 for a predetermined non-operational duration, while maintaining power of a fan 114 to blow on a cooling compressor 104 or a heat exchanger 108 when a predetermined temperature, or an operational duration has been reached. The apparatus 100 and method 200 also enables manual or automated bypassing of the powering off function for the cooling compressor 104 or heat exchanger 108.

As referenced in FIG. 1, the apparatus 100 teaches conservation of energy and increasing life of an air conditioning unit 102 comprising a cooling compressor 104, and a heating unit 106 comprising a heat exchanger 108. These units 102, 106 works to remove or add heat from/to a space, thus cooling or heating the space's average temperature. In one embodiment, the air conditioning unit 102 and heating unit 106 are operational with low voltage terminals that remotely connect to a thermostat 110 through Bluetooth or using a cable.

The thermostat 110 is used to control the conditions of the air in a conditioned space by sending 24 Volts Alternating Current control signals to an energy conservation apparatus 126 which is the PTX module that activates or deactivates the air conditioning and heating units 102, 106. The thermostat 110 detects and communicates a user selected temperature that is determinative of the air conditioning and heating units 102, 106. Based on the user selected temperature, operation of the air conditioning and heating units 102, 106 is performed. In other embodiments, a humidity sensor 128 works in conjunction with the thermostat 110 to detect humidity along with the temperature detected by the thermostat 110. In another embodiment, an intelligent sensor 129 works in conjunction with the thermostat 110 to detect a host of sensors from the conditioned room such as motion, lights, noise, mobile phone signals, TV signals, door locks position, time of day, etc., along with the temperature detected by the thermostat 110.

In some embodiments, the air conditioning unit 102 and heating unit 106 may include a Packaged Terminal Air Conditioners (PTAC) and a Packaged Terminal Heat Pumps (PTHP). Those skilled in the art will recognize that PTAC and PTHP are self-contained HVAC systems commonly found in hotels, motels, apartments, condos, schools, medical facilities and offices nationwide. Installation of the intelligent air conditioning and heating apparatus 100 represents a cost-effective measure to reduce energy consumption by HVAC industry workhorses.

In one embodiment, the apparatus 100 comprises a moisture proof encapsulated energy conservation apparatus module 126 that regulates the apparatus 100, and enables communication between the air conditioning unit 102, the heating unit 106, the thermostat 110, and the blower fan 114. The energy conservation module 126 comprises a combination of software, firmware, sensors, and circuitry designed to optimize efficiency of operation of air conditioning and heating units 102, 106 and blower fan 114 through intervening control of system component activity. The energy conservation module 126 comprises a thermostat terminal 122 and terminal 113 for communicating with the air conditioning unit and heater unit. Subtle influences by the energy conservation module 126 result in substantial savings in operating cost; usually about 10-12%.

In another embodiment, the apparatus 100 comprises a moisture proof encapsulated energy conservation apparatus module 126 embedded into the thermostat 110 with motion sensor as one integrated unit that communicates directly with the air conditioning unit 102, the heating unit 106, and the blower fan 114. The integrated unit comprises a combination of hardware, software, firmware, sensors, and circuitry designed to optimize efficiency of operation of air conditioning and heating units 102, 106 and blower fan 114 through intervening control of system component activity. The integrated unit comprises a terminal 113 for communicating with the air conditioning unit, heater unit and fan unit.

Further, the energy conservation module 126 powers off the air conditioning and heating unit 102, 106 after the thermostat 110 reaches a predetermined temperature but not the user selected set temperature, or an operational duration, such as 15 minutes. By temporarily powering off the cooling compressor 104 or heat exchanger 108, energy is saved and the life span of the air conditioning and heating units 102,106 are extended. After 3 minutes, the cooling compressor 104 or heat exchanger 108 power back on. In either case, while powered on or off, the fan 114 continues blowing.

The energy conservation module 126 is in communication with the fan 114, the cooling compressor 104, and the heat exchanger 108. In one embodiment, the energy conservation module 126 may include buttons or dials to manually or automatically set the differential temperature for the air conditioning and heating units to condition the air in a room to a temperature below or above the thermostat set temperature which is the pre-determined temperature. For example, if the user set the thermostat 110 to a temperature of 70 deg F. during the summer with the switch to cool, and the differential temperature in module 126 is set at 5 deg F., then the powering off of the compressor 104 will occur when the room temperature is at 75 deg F. (70 deg F.+5 deg F.). When the room reaches the module 126 pre-determined temperature of 75 deg F., the cooling compressor 104 cycle off to the non-operational mode. Similarly, in yet another example, if the user set the thermostat 110 to a temperature of 80 deg F. during the winter with the switch to heat, and the differential temperature in module 126 is set at 4 deg F., then the powering off of the heating element 108 will occur when the room temperature is at 76 deg F. (80 deg F.-4 deg F.).

In another embodiment, the module 126 does not have pre-determine temperature differential settings, but instead uses the duration of compressor or heater powered on to determine the cycle off to the non-operational mode.

However, while the cooling compressor 104 and heat exchanger 108 are non-operational, blower fan 114 continues blowing for a predetermined non-operational duration, such as about 3 minutes. However, in other embodiments, the blower fan 114 continues to run for about ten to sixty seconds. The blower fan 114 blows directly on the cooling compressor 104 or heat exchanger 108 to carry the cool or hot air, and thereby attempting to maintain the condition room temperature.

The blower fan 114 blows air across the condensation from the cooling compressor 104 or the dissipating heat from the heat exchanger 108 to try to maintain the pre-determined temperature without requiring operation of the cooling compressor 104 or heat exchanger 108. In one embodiment, the fan 114 comprises a low-speed fan and a high-speed fan that operate at variable times, depending on the position of the bypass switch 112a-b.

By temporarily powering off the cooling compressor 104 or heat exchanger 108, energy is saved. After 3 minutes, the cooling compressor 104 or heat exchanger 108 power back on. In either case, while powered on or off, the blower fan 114 continues blowing. Thus, in operation, every 15 mins of cooling compressor 104 or heat exchanger 108 run time, the cooling compressor 104 or heat exchanger 108 is forced to shut off for 3 minutes with the blower fan 114 continuing to run. If the cooling compressor 104 or heat exchanger 108 power off before the 15 minutes interval is reached due to the thermostat already reaching the set temperature point, the fan 114 continues to run for a variable period of time after the cooling compressor 104 or heat exchanger 108 has stopped, depending on the duration of the previous ON (powering on) and previous OFF (powering off) cycles of the cooling compressor 104 or heat exchanger 108.

In this manner, air from the fan 114 blows on the condensate from the cooling compressor 104 to produce cool air without requiring the cooling compressor 104 to be operational for at least 3 minutes. Similarly, air from the fan 114 blows on the dissipating heat from the heat exchanger 108 to produce warm air without requiring the heat exchanger 108 to be operational, also for at least 3 minutes. It is significant to note that studies show that heat exchanger 104 coils retain residual energy after the compressor has stop running. The heat exchanger 108 remains hot with residual energy after the heater has stopped running as well. The energy conservative module 126 (PTX) initiates the recovery of this otherwise wasted energy. The apparatus 100 takes advantage of heating and cooling energy that is, otherwise, lost.

It is significant to note that in many temperate regions, there is little temperature difference between the desired room temperature and the outside air temperature. As such, the cooling compressor 104 typically runs for three to fifteen minutes per cycle. There are climate zones, where, at certain times of the year, the temperature difference between outside air and room temperature is sizable and the cooling compressor 104 or the heater element 108 can run continuously for an extended period of time in order to reach the temperature set by the occupant. Often, the temperature set by the occupant is never reached, and the cooling compressor 104 runs non-stop throughout the day. In this situation, the energy conservation module 126 forces the cooling compressor 104 to power off temporarily for a few minutes, with the fan 114 continuing to run, anytime the cooling compressor 104 runs for approximately 15 continuous minutes. The fan 114 uses water condensed onto the evaporative coils to condition the air while the cooling compressor 104 is off. This results in a few minutes of almost energy free cooling. Finally, the water condensed on the coil is evaporated and the cooling compressor 104 re-starts automatically with the fan 114 running continuously throughout the process.

Furthermore, a bypass switch 112a-b overrides the energy savings function of powering off the cooling compressor 104 or heat exchanger 108, so as to maintain normal operation of the air conditioning and heating units 102, 106 in the event of extreme outside air temperature or humidity conditions.

When automatically bypassing the energy savings power off function, at least one intelligently sensed event must occur and be detected by various sensors and the microprocessor in 126. The intelligently sensed event may include, without limitation, detecting an ambient temperature, an ambient humidity, or both. Furthermore, the intelligently sensed event may also include: detecting the presence of a person in a room, detecting the presence of mobile phone signals in the room indicating occupant in the room, detecting body heat, detecting motion, detecting door lock positions of on or off, detecting television sounds, detecting the time of day, detecting television remote signals being used over a period of time, detecting noise from a door closing and opening. In this way, the energy saving power off function will not cause undue discomfort to the occupants. A typical application of the PTX is in hotel rooms and it is a confined conditioned space where the above-mentioned events are easy to sense.

Those skilled in the art will recognize that there are times when the outside air temperature is very hot during the summer, and forcing the compressor pause after 15 minutes for a few minutes, may not be suitable for the occupant. In such as case, the occupant can manually flip a bypass switch 112a to de-activate the cooling compressor 104 pause. During the winter when the outside air temperature maybe too cold, and forcing the heater pause after 15 minutes for a few minutes may not be suitable for the occupant. In such a case, the occupant can manually flip a bypass switch 112b to de-activate the heat exchanger 108 pause.

In other embodiments, the bypass switch 112a-b can be switched on or off by sensing the outside air temperature using a temperature and/or humidity sensor mounted outside the building or getting the temperature of the outside air from weather forecast from the Wi-Fi reception the air conditioning and heating unit. The bypass switch 112a-b can also be switched on or off remotely using radio frequency signal or Zig bee or Wi-Fi controls managed by the hotel management. In this manner, the apparatus 100 helps improve the efficiency by delivering additional heating or cooling capacity for a reduced amount of additional electric energy (kWh). The apparatus 100 also extends the service life of the equipment through greater efficiency and fewer cycles.

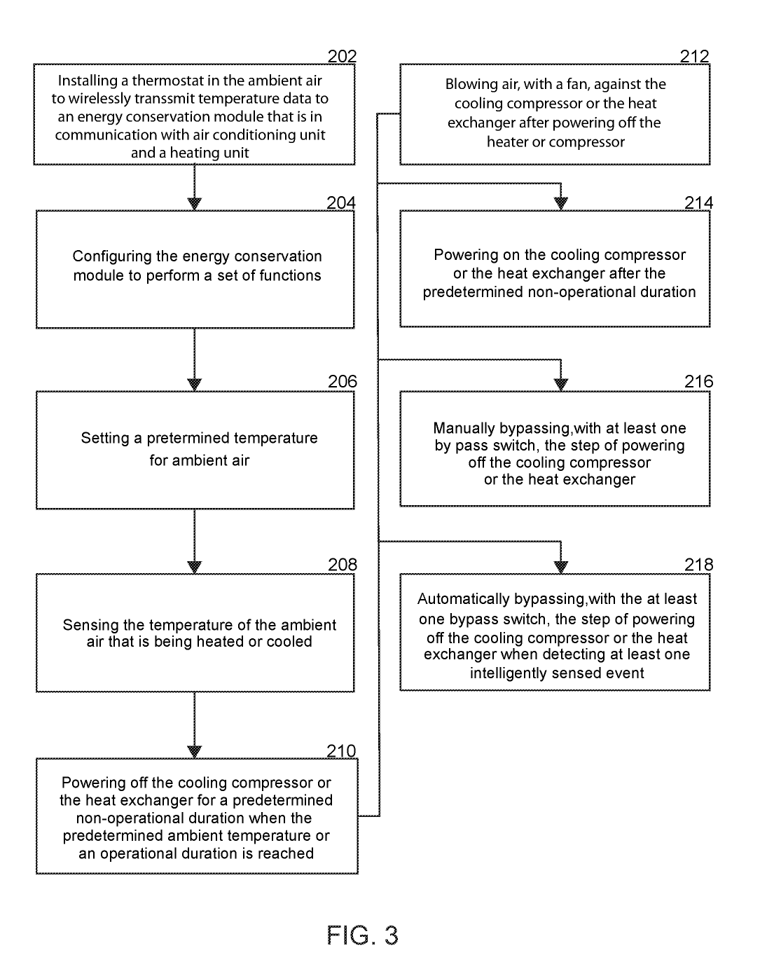

As referenced in FIG. 3, the method 200 of operating an intelligent air conditioning and heating system, comprises an initial Step 202 of installing a thermostat in the ambient air to wirelessly transmit temperature data to an energy conservation module that is in communication with an air conditioning unit and a heating unit. The air conditioning unit 102 comprising a cooling compressor 104, and a heating unit 106 comprising a heat exchanger 108. These units 102, 106 works to remove or add heat from/to a space, thus cooling or heating the space's average temperature. The thermostat detects the temperature.

A Step 204 may include configuring the energy saving unit to perform a set of functions. The energy conservation module 126 powers off the air conditioning and heating unit 102, 106 after the thermostat 110 reaches a predetermined temperature or an operational duration, such as 15 minutes. By temporarily powering off the cooling compressor 104 or heat exchanger 108, energy is saved and the life span of the air conditioning and heating units 102,106 are extended.

In some embodiments, a Step 206 comprises setting a predetermined temperature for ambient air. This temperature is derived from the thermostat set temperature as selected by the user. A Step 208 may include sensing the temperature of the ambient air that is being heated or cooled. A further Step 210 includes powering off the cooling compressor or the heat exchanger for a predetermined non-operational duration when the predetermined ambient temperature or an operational duration is reached. The step of powering off the cooling compressor or the heat exchanger may be actuated remotely through Bluetooth technology, radio frequency signals, Wi-Fi controls, or ZigBee.

A Step 212 includes activating the blower fan to blow air against the cooling compressor or the heat exchanger after powering off the heater or compressor. Air from the fan 114 blows on the condensate from the cooling compressor 104 to produce cool air without requiring the cooling compressor 104 to be operational for at least 3 minutes. Similarly, air from the fan 114 blows on the dissipating heat from the heat exchanger 108 to produce warm air without requiring the heat exchanger 108 to be operational, also for at least 3 minutes. In another embodiment, an alternative step includes operating the fan for a variable period of time if the cooling compressor or the heat exchanger power off before the operational duration is complete.

The method 200 may also include a Step 214 of powering on the cooling compressor or the heat exchanger after the predetermined non-operational duration. After the non-operational duration of about 3 minutes, the cooling compressor or heat exchanger power back on, and the fan continues blowing. A Step 216 comprises manually bypassing, with at least one bypass switch, the step of powering off the cooling compressor or the heat exchanger. The bypass switch 112a-b overrides the function of powering off the cooling compressor 104 or heat exchanger 108, so as to maintain normal operation of the air conditioning and heating units 102, 106 due to extreme temperature or humidity conditions.

A Step 218 comprises automatically bypassing, with the at least one bypass switch, the step of powering off the cooling compressor or the heat exchanger when detecting at least one intelligently sensed event. The intelligently sensed event may include, without limitation, detecting a temperature, such as 72° Fahrenheit, for example. The intelligently sensed event may also include detecting body heat with an infrared heat detector, so as to bypass the powering off of the cooling compressor when persons are present in a room, for example.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method of operating an intelligent air conditioning and heating system, the method comprising:
installing a thermostat in the ambient air to wirelessly transmit temperature data to an energy conservation module that is in communication with air conditioning unit and a heating unit;
configuring the energy conservation module to perform a set of functions comprising:
setting a predetermined temperature for ambient air;
sensing the temperature of the ambient air that is being heated or cooled;
powering off the cooling compressor or the heat exchanger for a predetermined non-operational duration when the predetermined ambient temperature derived from thermostat predetermined set temperature is reached or an operational duration is reached;
blowing air, with a fan, against the cooling compressor or the heat exchanger after powering off the heater or compressor;
powering on the cooling compressor or the heat exchanger after the predetermined non-operational duration;
manually bypassing, with at least one bypass switch, the step of powering off the cooling compressor or the heat exchanger; and/or
automatically bypassing, with the at least one bypass switch, the step of powering off the cooling compressor or the heat exchanger when detecting at least one intelligently sensed event.

2. The method of claim 1, further comprising a step of operating the fan for a variable period of time if the cooling compressor or the heat exchanger power off before the operational duration is complete.

3. The method of claim 1, wherein the operational duration is about fifteen minutes.

4. The method of claim 1, wherein the predetermined non-operational duration is about three minutes.

5. The method of claim 1, wherein the air conditioning and heating unit comprises a packaged terminal air conditioner and a packaged terminal heat pump.

6. The method of claim 1, wherein the air conditioning and heating unit is operational with low voltage terminals that remotely connect to the thermostat through Bluetooth.

7. The method of claim 1, wherein the air conditioning and heating unit is operational with low voltage terminals that connects to the thermostat through hard wires.

8. The method of claim 1, wherein the intelligent air conditioning and heating system is in communication with the fan, the cooling compressor, and the heat exchanger.

9. The method of claim 1, wherein the energy conservation module comprises a thermostat terminal for communicating temperature and a microprocessor for communicating temperature for determining and triggering the predetermined non-operational duration and the operational duration.

10. The method of claim 1, wherein the step of manually powering off the cooling compressor or the heat exchanger is actuated remotely through Bluetooth technology, radio frequency signals, Wi-Fi controls, or ZigBee.

11. The method of claim 1, wherein the at least one intelligently sensed event includes at least one of the following: detecting the presence of a person in a room, detecting the presence of mobile phone signals in the room indicating occupant in the room, detecting body heat, detecting an ambient temperature, detecting an ambient humidity, detecting motion, detecting door lock positions of on or off, detecting television sounds, detecting the time of day, detecting television remote signals being used over a period of time, detecting noise from a door closing and opening.

12. The method of claim 1, wherein the fan comprises a low speed fan-relay and a high-speed fan relay.

13. A method of operating an intelligent air conditioning and heating system, the method consisting of:
installing a thermostat in the ambient air to wirelessly transmit temperature data to an energy conservation module that is in communication with air conditioning unit and a heating unit;
configuring the energy saving unit to perform a set of functions comprising:
setting a predetermined temperature for ambient air;
sensing the temperature of the ambient air that is being heated or cooled;
powering off the cooling compressor or the heat exchanger for a predetermined non-operational duration when another predetermined ambient temperature or an operational duration is reached,
whereby the step of manually powering off the cooling compressor or the heat exchanger is actuated remotely through Bluetooth technology, radio frequency signals, Wi-Fi controls, or ZigBee;
blowing air, with a fan, against the cooling compressor or the heat exchanger after powering off the heater or compressor;
operating the fan for a variable period of time if the cooling compressor or the heat exchanger power off before the operational duration is complete;
powering on the cooling compressor or the heat exchanger after the predetermined non-operational duration;
manually bypassing, with at least one bypass switch, the step of powering off the cooling compressor or the heat exchanger; and/or
automatically bypassing, with the at least one bypass switch, the step of powering off the cooling compressor or the heat exchanger when detecting at least one intelligently sensed event,
whereby the at least one intelligently sensed event detecting an ambient temperature, detecting an ambient humidity, detecting the presence of a person in a room, detecting the presence of mobile phone signals in the room indicating occupant in the room, detecting body heat, detecting motion, detecting door lock positions of on or off, detecting television sounds, detecting the time of day, detecting television remote signals being used over a period of time, detecting noise from a door closing and opening.

14. The method of claim 13, wherein the operational duration is about fifteen minutes.

15. The method of claim 13, wherein the predetermined non-operational duration is about three minutes.

16. The method of claim 13, wherein the energy conservation module comprises a thermostat terminal for communicating temperature and a microprocessor for communicating temperature for determining and triggering the predetermined non-operational duration and the operational duration.

17. The method of claim 13, wherein the fan comprises a low speed fan-relay and a high-speed fan relay.

18. An intelligent air conditioning and heating apparatus, the apparatus comprising:
a thermostat interface to receive the thermostat data remotely or by hard wired;
an interface with air conditioning unit having a cooling compressor and a heater having a heat exchanger;
a microprocessor based energy conservation module powering off the cooling compressor or the heat exchanger for a predetermined non-operational duration when another predetermined ambient temperature derived from the thermostat programmed predetermined temperature or an operational time duration is reached;
a fan control signal comprising a low-speed fan and a high-speed fan signal causing the fan blowing air across the cooling compressor and the heat exchanger after powering off the heater or compressor,
whereby the energy conservation module further powers on the cooling compressor and the heat exchanger after the predetermined non-operational time duration has lapsed; and
at least one bypass switch manually bypassing the step of powering off the cooling compressor or the heat exchanger, the at least one bypass switch further automatically bypassing the step of powering off the cooling compressor or the heat exchanger when detecting at least one intelligently sensed event.

19. The apparatus of claim 18, wherein the energy conservation module comprises a thermostat terminal for communicating temperature and a microprocessor for communicating temperature for determining and triggering the predetermined non-operational duration and the operational duration.

20. The apparatus of claim 18, wherein the air conditioning and heating unit comprises a packaged terminal air conditioner and a packaged terminal heat pump.

21. The apparatus of claim 18, wherein the energy conservation module is embedded into the thermostat together with motion sensor as an integrated unit.
